(19) United States
(12) Patent Application Publication
(10) Pub. No.: US 2007/0081474 A1
(43) Pub. Date: Apr. 12, 2007

(54) Wireless terminal and program

(76) Inventor: Takehiko Sasaki, Kanagawa (JP)

Correspondence Address: FROMMER LAWRENCE & HAUG LLP, 745 FIFTH AVENUE, NEW YORK, NY, 10151, US

(21) Appl. No.: 11/543,487

(22) Filed: Oct. 5, 2006

(30) Foreign Application Priority Data
Oct. 7, 2005 (JP) P2005-294631

(51) Int. Cl. H04L 12/28; H04L 12/56

(52) U.S. Cl. 370/254; 370/400

(57) ABSTRACT

A wireless terminal communicable in an ad hoc mode includes a wireless level detector that detects the wireless level for a neighbor node on a logical network, and a neighbor node number display controller that displays information indicative of the number of neighbor nodes communicable in the ad hoc mode on an incorporated or externally connected display device based on the detection result detected from the wireless level detector.

### CROSS REFERENCES TO RELATED APPLICATIONS

The present invention contains subject matter related to Japanese Patent Application JP2005-294631 filed in the Japanese Patent Office on Oct. 7, 2005, the entire contents of which being incorporated herein by reference.

### BACKGROUND OF THE INVENTION

1. Field of the Invention

The invention described herein relates to a technology that allows an individual wireless terminal to be used to visually check the state of a logical network connected in an ad hoc mode.

The present invention also relates to a wireless terminal that employs the technology and a program that employs the technology.

2. Description of the Related Art

Even in an environment with no wireless communication platform, such as an access point, a wireless ad hoc network is used to cascade communication from one wireless terminal to another, allowing communication with a destination wireless terminal or Internet connection point.

This characteristic allows the wireless ad hoc network to be used as a unit for providing a networking environment in sparsely-populated areas or a temporal networking environment. The wireless ad hoc network is also used as one of approaches to reducing cost necessary for establishing communication platform. JP-A-2004-289839 is exemplified as a related art document.

### SUMMARY OF THE INVENTION

In a wireless ad hoc network, a logically constructed network configuration is not linked to an actually existing wireless terminal or access point.

Thus, it is disadvantageously difficult to keep track of what route data packets pass through and locate a failure point when a trouble has occurred.

Some of existing state-monitoring servers have processing capabilities of displaying information on the state of nodes and communication routes.

However, such existing processing capabilities collect necessary information through the same communication route as that for data packets.

Thus, when the network is disconnected, the state of nodes (wireless terminals or access points) may not be displayed. Furthermore, the processing capabilities may often not be used during their installation.

The inventor proposes a method for incorporating processing capabilities presented below into each wireless terminal.

(A) Capability of Displaying the Number of Neighbor Nodes

To achieve this capability, a wireless terminal is equipped with the following processing capabilities:
(a) Processing capability of detecting the wireless level for a neighbor node on a logical network
(b) Processing capability of displaying information indicative of the number of neighbor nodes communicable in an ad hoc mode on an incorporated or externally connected display device based on the detection result
   (B) Capability of Displaying the Wireless Level of a Neighbor Node

To achieve this capability, the wireless terminal is equipped with the following processing capabilities:
(a) Processing capability of detecting the wireless levels for the neighbor nodes on the logical network
(b) Processing capability of displaying the detected wireless level for each of the neighbor nodes on the incorporated or externally connected display device
   (C) Capability of Displaying the Reached/Unreached State

To achieve this capability, the wireless terminal is equipped with the following processing capabilities:
(a) Processing capability of detecting whether or not an ad hoc-routing communication route is established between the user's terminal and a terminal apparatus that is specified as a destination connection point
(b) Processing capability of displaying the detection result on the incorporated or externally connected display device

By employing the technology according to an embodiment of the invention, individual wireless terminals can be used to check various states of ad hoc routing without depending on a state-monitoring server. Furthermore, even during the installation stage of the ad hoc network, the user can check various states of the ad hoc routing.

### BRIEF DESCRIPTION OF THE DRAWINGS

FIG. 1 shows an exemplary configuration of a wireless terminal;

FIG. 2 shows another exemplary configuration of a wireless terminal;

FIG. 3 shows another exemplary configuration of a wireless terminal used in an exemplary form;

FIG. 4 shows an exemplary configuration of capabilities that are incorporated in the ad hoc network state screen generator;

FIGS. 5A to 5C show examples of display corresponding to the neighbor node number display capability;

FIGS. 6A and 6B show examples of display corresponding to the wireless level display capability;

FIG. 7A to 7C show examples of display corresponding to the actual connection node display capability;

FIG. 8A to 8C show examples of display corresponding to the node identification information display capability;

FIGS. 9A and 9B show examples of display corresponding to the reached/unreached state display capability;

FIGS. 10A and 10B show other examples of display corresponding to the reached/unreached state display capability;

FIG. 11 shows an example of a display screen;

FIG. 12 shows the relationship between identification colors assigned to terminals and neighbor nodes; and

FIG. 13 shows an exemplary application system.

### DESCRIPTION OF THE PREFERRED EMBODIMENTS

An exemplary form of a wireless terminal having processing capabilities according to an embodiment of the invention will be described below.

Well known or publicly known technologies in the art are applied to the portions that are not particularly illustrated or described herein.

Each of the exemplary forms described below is one exemplary form according to an embodiment of the invention, which is not limited these exemplary forms.

(A) Examples of Wireless Terminal

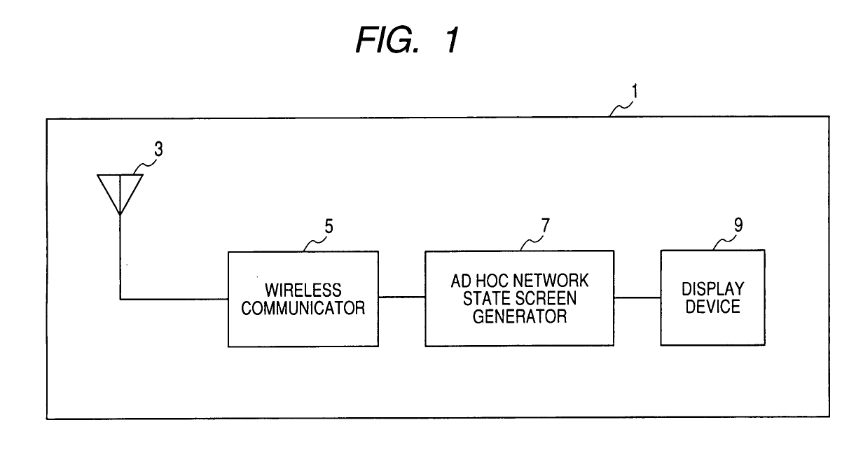

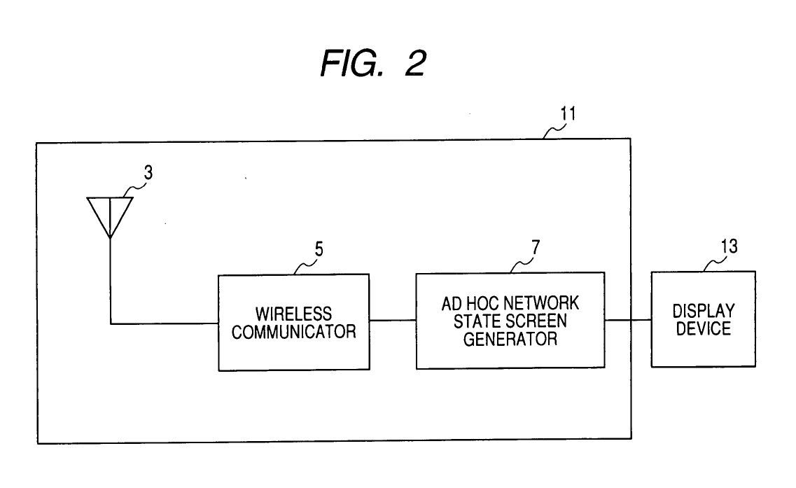

FIGS. 1 and 2 show representative examples of the configuration of a wireless terminal. FIGS. 1 and 2 only show main processing capabilities and elements (apparatuses). An actual wireless terminal has other known processing capabilities and elements (apparatuses).

A wireless terminal 1 shown in FIG. 1 includes a wireless antenna 3, a wireless communicator 5, an ad hoc network state screen generator 7 and a display device 9.

The wireless communicator 5 is a communication device having a wireless communication capability that supports an ad hoc mode. For example, wireless devices in compliance with IEEE 802.11 standard, such as communication devices that support IEEE 802.11a, IEEE 802.11b, IEEE 802.11e and IEEE 802.11g, are used.

The ad hoc network state screen generator 7 provides a processing capability of visually presenting a user of the terminal the state of the ad hoc network in which the user's terminal participates.

Information that may be required for the visual presentation is autonomously exchanged between wireless terminals. Examples of information to be exchanged include available channels, addresses of neighbor nodes, information by which neighbor nodes are distinguished, and route establishment information exchanged between application layers (OSI: open system interconnection).

The capability of the ad hoc network state screen generator 7 is provided through software processes executed on a CPU or microprocessor housed in the wireless terminal 1.

Software (programs) to be executed is stored in a storage region (not shown). A RAM, ROM, hard disk drive, optical storage medium or the like is used as the storage region depending on the form of product of the wireless terminal 1.

The display device 9 may be dedicated to presenting the state of the ad hoc network, but a general-purpose product is used in this exemplary form. While the form of product of the display device 9 differs depending on the form of product of the wireless terminal 1, a liquid crystal display panel, an organic EL display panel or other flat panels will be typically used.

The display device 9 is not necessarily housed in the wireless terminal 1.

FIG. 2 shows an exemplary form of product of a wireless terminal 11 in which a display device is not housed. In this case, the wireless terminal 11 only houses the wireless antenna 3, the wireless communicator 5 and the ad hoc network state screen generator 7. A display device 13 separate from the wireless terminal 11 is externally connected to check the state of the ad hoc network if necessary.

One example of these wireless terminals is a system with a built-in instrument. A system with a built-in instrument includes any products into which a computer system is incorporated.

Examples thereof include automobiles, information appliances (for example, television receivers, refrigerators, air conditioners, microwave ovens, telephones and video recorders), personal digital assistants (such as mobile computers, mobile phones, mobile game consoles and electronic books), displays, printers, network cameras, digital cameras, game consoles, general-purpose computers, timepieces, electronic billboards and mobile music players.

Another example of the wireless terminal is a sensor node. A sensor node is a wireless terminal in which a power supply, a microprocessor (CPU), a sensor and a wireless communication capability are all incorporated. Examples of the sensor include a temperature sensor, humidity sensor, acceleration sensor and other detection devices. The sensor node is useful to keep track of the state of an object, person, environment and the like in a real-time manner.

A sensor node is often configured such that the body of the apparatus is typically molded or a display device may not be incorporated therein.

(B) Examples of Incorporated Capabilities

An example of processing capabilities that are incorporated in the ad hoc network state screen generator 7 that provides the state of the ad hoc network to the user will be described below.

As described above, the basic configuration of the wireless terminal is classified into two configurations, one with a display device incorporated and the other with a display device externally connected. In fact, either configuration allows the user to keep track of the state of the ad hoc network through the wireless terminal.

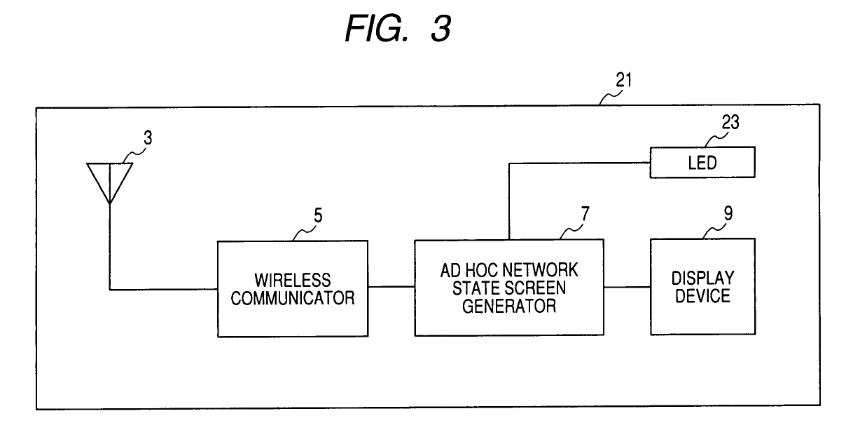

The following description will be given with reference to a wireless terminal 21 configured as shown in FIG. 3. By adding a multicolor-emitting LED 23 to the configuration described above, the wireless terminal 21 allows the user to visually check neighbor nodes on a logical network. The wireless terminal 21 may be differently configured from that shown in FIG. 3 in such a way that it has a plurality of LEDs, each corresponding to each color.

The LED is of course one example of a light emitting element and it is not intended to limit the exemplary form thereto.

Although the wireless terminal 21 is shown as having the display devise 9 incorporated therein, the wireless terminal 21 may have the display device 23 externally connected.

The LED itself may also be located external to the wireless terminal 21.

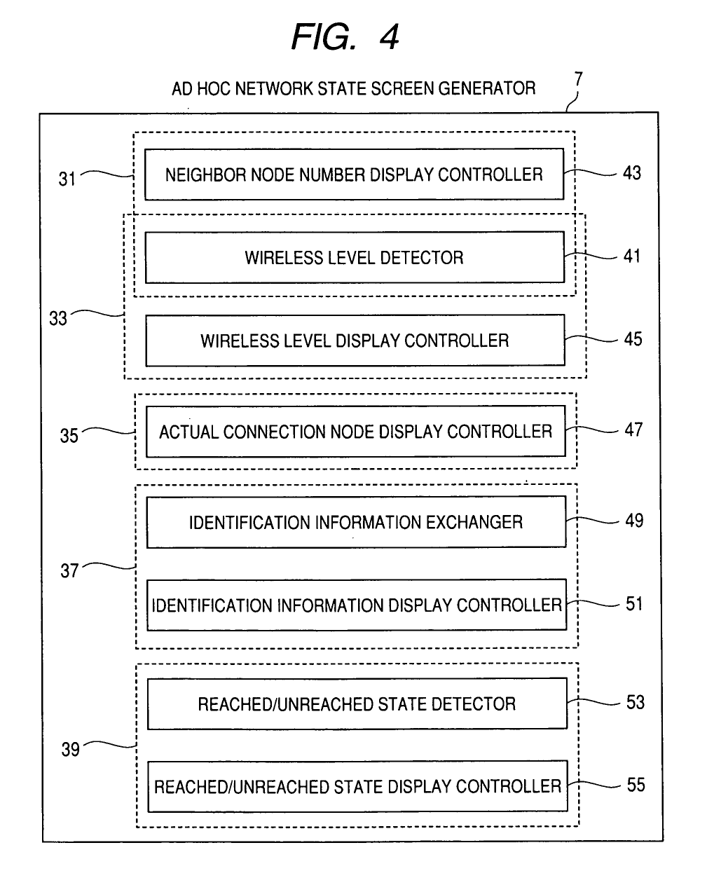

FIG. 4 shows an exemplary configuration of capabilities that are incorporated in the ad hoc network state screen generator 7. In this exemplary form, the ad hoc network state screen generator 7 has five processing capabilities, that is, a neighbor node number display capability 31, a wireless level display capability 33, an actual connection node display capability 35, a node identification information display capability 37 and a reached/unreached state display capability 39.

Each of the capabilities will be described below.

(B-1) Neighbor Node Number Display Capability

The neighbor node number display capability 31 corresponds to a capability of displaying the number of neighbor nodes capable of transmitting and receiving data packets to and from the user's terminal, including nodes (wireless terminals) that are not actually selected for an actual connection route (representative route) in ad hoc communication. This capability allows the user to check neighbor nodes located around each wireless terminal at a glance.

The term neighbor node used herein is a node located nearby on a logical network.

The neighbor node number display capability 31 is provided through a wireless level detector 41 and a neighbor node number display controller 43.

The wireless level detector 41 has a processing capability of detecting the wireless level for a neighbor node on a logical network and is also used in the wireless level display capability 33. The wireless level detector 41 detects whether the wireless level of a neighbor node that the user's terminal receives is high or low. Considering what this capability aims to, it is enough to know the number of neighbor nodes that can transmit and receive data packets to and from the user's terminal (the number of neighbor nodes from which data packets reach the user's terminal).

The neighbor node number display controller 43 corresponds to a capability of displaying information indicative of the number of neighbor nodes communicable in an ad hoc mode on the display device 9 based on the detection result from the wireless level detector 41. The number of nodes to be displayed may be limited to the number of nodes with a wireless level greater than or equal to a threshold value, because when the wireless level is too low, the node in question may not be used as a neighbor node in the first place.

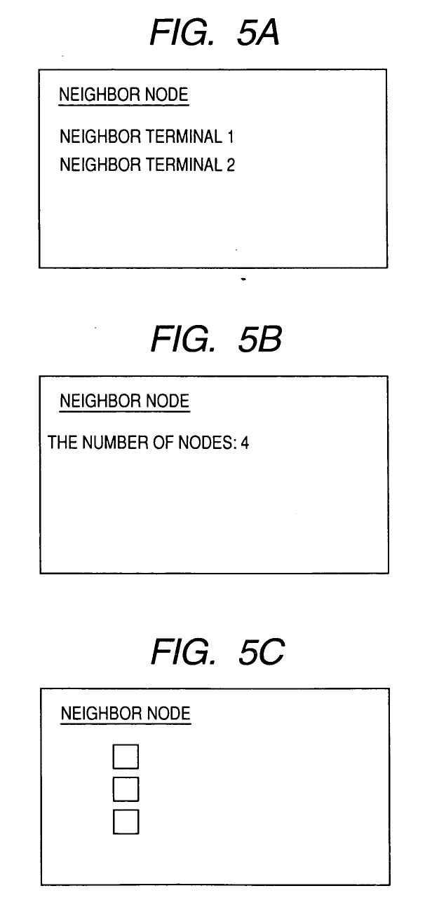

FIGS. 5A to 5C show examples of how to display the number of neighbor nodes.

FIG. 5A is an example in which the number of neighbor nodes is expressed as a serial number. This example shows that there are two neighbor nodes around the user's terminal.

FIG. 5B is an example that shows how many neighbor nodes are present. This example shows that there are “four” neighbor nodes around the user's terminal.

FIG. 5C is an example in which the number of neighbor nodes is expressed as the number of marks, symbols or pictograms. In this example, a square mark represents one neighbor node. That is, it is seen that there are three neighbor nodes around the user's terminal.

In addition to the above examples, a network address of the neighbor node (MAC address, for example) or the name of the neighbor node may be used and listed as a character string.

(B-2) Wireless Level Display Capability

The wireless level display capability 33 corresponds to a capability of displaying the wireless level for each neighbor node in the form of a list. This capability allows the user to check whether the wireless level of each neighbor node is high or low at a glance.

The wireless level display capability 33 is provided through the wireless level detector 41 and a wireless level display controller 45.

As described above, the wireless level detector 41 has the processing capability of detecting the wireless level for a neighbor node on a logical network.

The wireless level display controller 45 corresponds to a capability of displaying the wireless level for each neighbor node detected by the wireless level detector 41 on the display device 9.

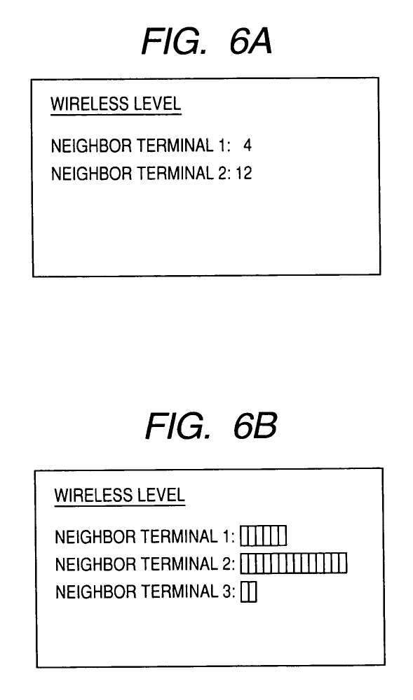

FIGS. 6A and 6B show examples of how to display the wireless level. FIG. 6A is an example in which the wireless level for each neighbor node is expressed in number. In this example, it is seen that there are two neighbor nodes around the user's terminal and that the “neighbor terminal 1” has a wireless level of “4” and the “neighbor terminal 2” has a wireless level of “12”.

FIG. 6B is an example in which the wireless level for each neighbor node is expressed in the form of an indicator (the length of a bar chart). In this example, it is seen that there are three neighbor nodes around the user's terminal and that the “neighbor terminal 1” has a wireless level of “level 6”, and the “neighbor terminal 2” has a wireless level of “level 14”, and the “neighbor terminal 3” has a wireless level of “level 2”.

FIGS. 6A and 6B are examples in which neighbor nodes are displayed in conjunction with the method shown in FIG. 5A. Therefore, among the examples of displaying the number of neighbor nodes, methods for displaying individual neighbor nodes in an independent mode can also be combined with the methods shown in FIGS. 6A and 6B. For example, the display of wireless levels can also be combined with the example of display shown in FIG. 5C.

(B-3) Actual Connection Node Display Capability

The actual connection node display capability 35 corresponds to a capability of displaying information indicative of a neighbor node that the user's terminal actually uses for connection on a logical network on an incorporated or externally connected display device. This capability allows the user to check through which neighbor node data packets are transferred to the representative route used by a monitoring server, an Internet gate or the like at a glance.

The actual connection node display capability 35 is provided through an actual connection node display controller 47.

A neighbor node with the highest wireless level is basically selected for the representative route, but the neighbor node is not limited thereto.

The actual connection node display controller 47 acquires information on the neighbor node actually used for connection among available nodes to be selected and displays it on the display device 9. This capability allows the user to identify the wireless terminal that is the hopping destination of data packets. Thus, when a communication trouble occurs, the failure point is easily located.

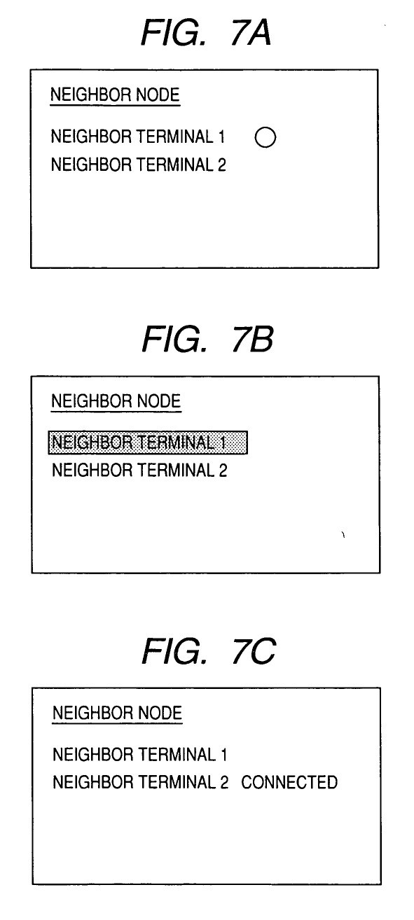

FIGS. 7A to 7C show examples of how to display the actual connection node.

FIG. 7A shows an example in which in the list of neighbor nodes located around the user's terminal, only the neighbor node actually used for connection is marked with a symbol indicative of being selected. In this example, an open circle mark indicative of being selected is placed next to the “neighbor terminal 1.” Of course, any symbol can be used.

FIG. 7B shows an example in which in the list of neighbor nodes located around the user's terminal, the display area corresponding to the neighbor node actually used for connection is colored or highlighted.

In this example, the neighbor terminal 1 is the actual connection node. In FIG. 7B, this state is shown as shaded.

FIG. 7C shows an example in which in the list of neighbor nodes located around the user's terminal, a text of “connected” is displayed at a position near the neighbor node actually used for connection. In this example, the “neighbor terminal 2” is “connected.”

In addition to the above examples, the connected state can be expressed by coloring the indicator indicative of the wireless level mentioned above.

(B-4) Node Identification Information Display Capability

The node identification information display capability 37 corresponds to a capability of displaying information by which the user's node can be distinguished from other neighbor nodes. By displaying the information that distinguishes the user's node from other neighbor nodes, the user can visually check the relationship between the user's terminal and neighbor nodes located therearound. This display capability is also used in conjunction with other display capabilities.

The node identification information display capability 37 is provided through an identification information exchanger 49 and an identification information display controller 51.

The identification information exchanger 49 has a processing capability of exchanging information by which the user's node is distinguished from other neighbor nodes. Any identification information may be used as long as identification information of each terminal is different from that of neighbor nodes therearound.

The identification information display controller 51 has a processing capability of displaying exchanged identification information on the display device 9.

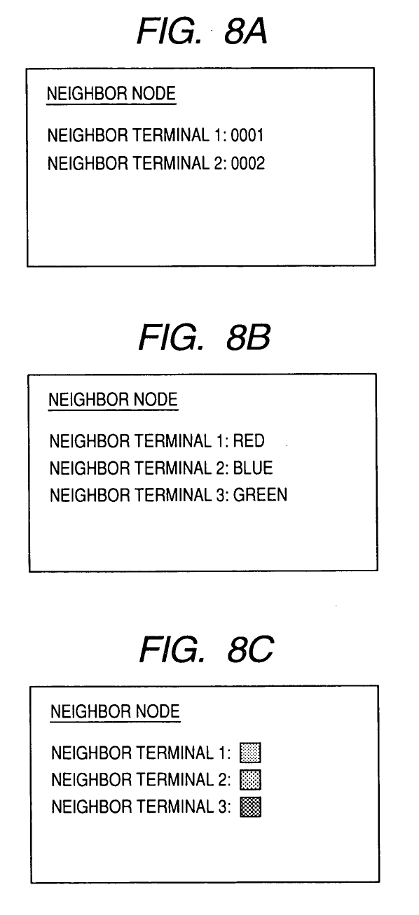

FIGS. 8A to 8C show examples of how to display node identification information.

FIG. 8A is an example in which identification character strings exchanged between neighbor nodes are displayed. In this example, identification number “0001” is assigned to the “neighbor terminal 1” and identification number “0002” is assigned to the “neighbor terminal 2.” The identification character string is of course not limited to an identification number, but may be a network address or an instrument-specific number.

FIG. 8B is an example illustrating what color information is assigned to each neighbor node. In this example, “red” is assigned to “neighbor terminal 1”, and “blue” is assigned to “neighbor terminal 2”, and “green” is assigned to “neighbor terminal 3.”

It is desirable to control the emission of the LED 23 based on an assigned identification color. If each LED 23 emits its identification color, it is also possible to know the relationship in terms of closeness on the logical network among neighbor nodes located away from the user's terminal. That is, it is possible to know the relationship in terms of closeness on the logical network as physical entities.

FIG. 8C is an example illustrating what pattern information is assigned to each neighbor node. In this example, the “neighbor terminal 1”, “neighbor terminal 2” and “neighbor terminal 3” use different patterns. Use of such a display form also allows neighbor node identification. The pattern may be a characteristic pattern or the body color that the housing of each neighbor node inherently has. These patterns or colors can be exchanged through ad hoc communication. In this case, neighbor nodes can be physically identified without using the LED 23.

(B-5) Reached/Unreached State Display Capability

The reached/unreached state display capability 39 corresponds to a capability of displaying whether or not the route to a network terminal (including not only a wireless terminal but also a wired terminal), which is the destination that the user's terminal is connected to, is established. This capability allows the user to check not only the connected state to the nearest neighbor node selected for the representative route, but also the reached/unreached state between the application layers at the both ends of the communication route at an individual wireless terminal level.

That is, it is possible to check the normality of communication on the whole network at a wireless terminal level.

The reached/unreached state display capability 39 is provided through a reached/unreached state detector 53 and a reached/unreached state display controller 55.

The reached/unreached state detector 53 has a processing capability of detecting whether or not an ad hoc-mode communication route is established between the user's terminal and a terminal apparatus specified as a destination connection point. Specifically, it is a processing capability of detecting whether or not the communication route to the final connection point is established based on the route information acquired through internode information exchange.

The reached/unreached state display controller 55 corresponds to a capability of displaying the result detected by the reached/unreached state detector 53 on the display device 9.

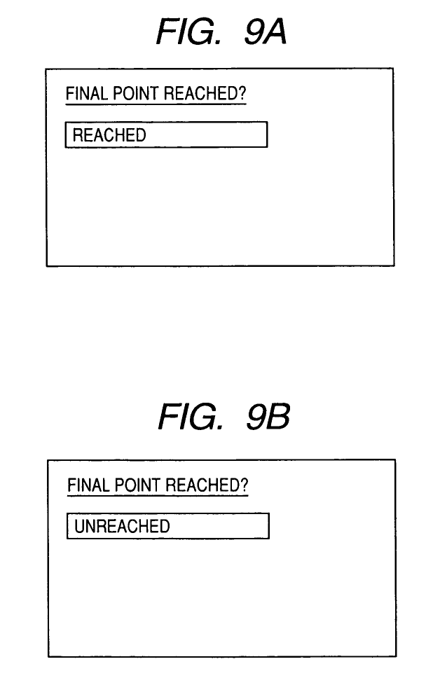

FIGS. 9A and 9B show examples of how to display the reached/unreached state. FIGS. 9A and 9B are examples in which text information shows whether reached or not.

FIG. 9A is an example displaying the state in which a route to the final destination connection point has been established by ad hoc routing. In the figure, this state is expressed by “reached.”

FIG. 9B is an example displaying the state in which a route to the final destination connection point has not been established. In this case, it is necessary to locate where the trouble has occurred. In the figure, this state is expressed by “unreached.”

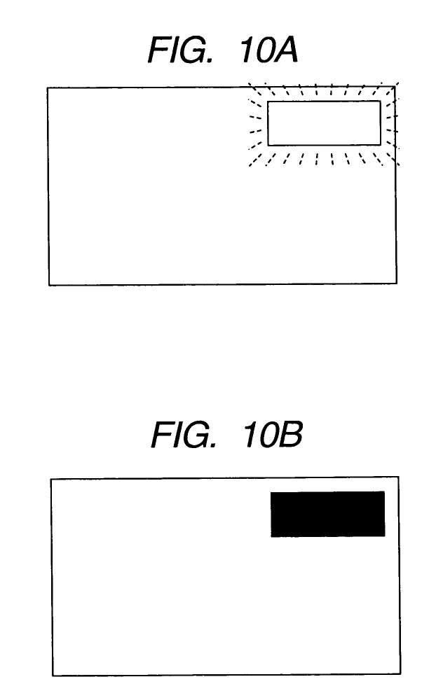

In addition to the above examples, it is also possible to show whether reached or not by turning on or off an LED or a specific display area. FIGS. 10A and 10B show examples of display corresponding to this approach.

FIG. 10A is an example in which a turned-on LED or other light emitting element shows that packet data has reached the final connection point.

In FIG. 10B, a turned-off LED or other light emitting element shows that packet data has not reached the final connection point.

(C) Example of Display Screen

In the above description, examples of display corresponding to the individual capabilities have been explained. In this section, an example of display screen to be actually used will be illustrated.

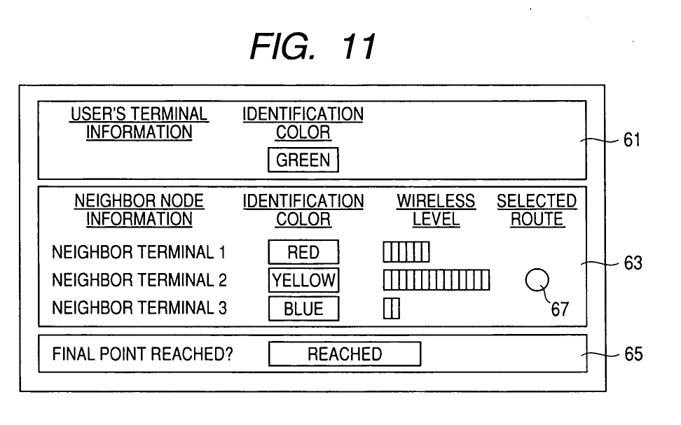

FIG. 11 is an exemplary display configured such that the five kinds of information described above can be checked on a single screen.

This display screen includes a user's terminal information field 61, a neighbor node information field 63 and a reached/unreached state notification field 65.

In the user's terminal information field 61, an identification color assigned to the user's terminal different from those of neighbor nodes is displayed. In this example, the identification color is “green.”

In the neighbor node information field 63, information indicative of the number of neighbor nodes (neighbor terminal 1 to neighbor terminal 3), identification colors assigned to the neighbor nodes, wireless levels corresponding to the wireless nodes and an actual connection route (selected route) are displayed.

In this example, the number of neighbor nodes is three. It is also seen that the identification color of the neighbor terminal 1 is “red” and the wireless level thereof is “level 6.” Similarly, it is seen that the identification color of the neighbor terminal 2 is “yellow” and the wireless level thereof is “level 14.” It is seen also that the identification color of the neighbor terminal 3 is “blue” and the wireless level thereof is “level 2.”

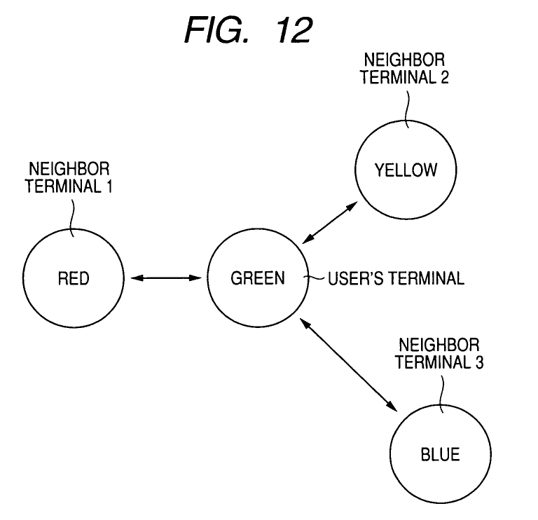

FIG. 12 shows the corresponding positional relationship. The display screen alone may not inform the user which neighbor terminal corresponds to the hopping destination.

However, each of the wireless terminals in this exemplary form has a capability of driving the LED 23 to emit the identification color assigned to that terminal. Therefore, the user checks the identification color of the LED mounted on the wireless terminal to instantly know which wireless terminal is the hopping destination and how high the wireless level between the user's terminal and that wireless terminal.

Of course, for the other wireless terminals, the user can check if they are recognized as neighbor terminals and the states of their wireless levels by correlating the identification colors on the display screens with the emission colors from the wireless terminals.

Furthermore, it is seen that the user's terminal forms an actual connection route (selected route) between the user's terminal and the neighbor terminal 2. In the figure, this selected state is shown by the circular mark 67.

The reached/unreached state notification field 65 displays whether or not the final connection point has been reached. FIG. 11 shows that it has been reached.

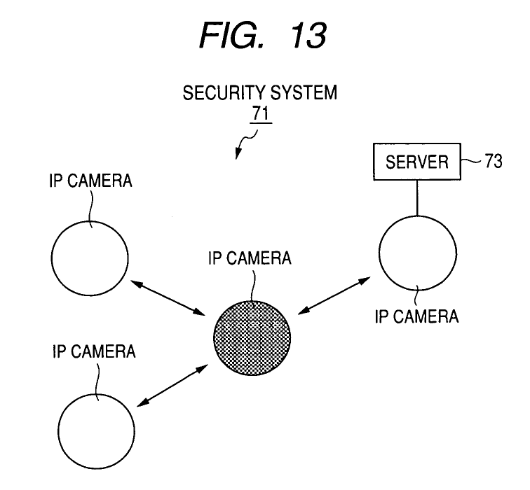

FIG. 13 shows the relationship between the user's terminal and the final connection point. FIG. 13 represents a security system 71. In this example, wireless terminals are IP cameras that support the ad hoc communication capability. There are five IP cameras connected on the ad hoc network and they are connected to a server 73 via one of the IP cameras.

In FIG. 13, the IP camera (wireless terminal) that displays the display screen shown in FIG. 11 is shown as shaded.

As shown in FIG. 13, it takes three hops from the user's terminal to the server 73, which is the final connection point, including the ad hoc communication portion.

By providing this capability, it is seen that the user's terminal is connected to the server 73 and an application service is available.

(D) Effect of Exemplary Forms

As described above, by incorporating the ad hoc network state screen generator 7 in a wireless terminal, the user can check various states of ad hoc routing on individual wireless terminals without having to depend on a state-monitoring server.

Furthermore, even during the installation stage of the ad hoc network, the user can check the hopping destination neighbor node (wireless terminal), the number of wireless-connectable neighbor nodes and wireless levels thereof, whether or not the final connection point has been reached, and other various states of ad hoc routing.

(E) Other Exemplary Forms

(a) In the above exemplary form, the description has been given with reference to the case where the ad hoc network state screen generator 7 includes the five capabilities of the neighbor node number display capability 31, the wireless level display capability 33, the actual connection node display capability 35, the node identification information display capability 37 and the reached/unreached state display capability 39.

However, it is possible to incorporate one of the five capabilities or any combination thereof into a wireless terminal.

(b) In the above exemplary form, the description has been given with reference to the case where the five IP cameras form the security system.

However, examples of the system to which the invention is applied are not limited thereto. It is applicable to any system, as long as the system uses an ad hoc network.

(c) Various variations of the above exemplary form are conceivable within the spirit of the invention. Various modifications and applications created or combined based on the description herein are also conceivable.

It should be understood by those skilled in the art that various modifications, combinations, sub-combinations and alterations may occur depending on design requirements and other factors insofar as they are within the scope of the appended claims or the equivalents thereof.

What is claimed is:

1. A wireless terminal communicable in an ad hoc mode, the wireless terminal comprising:
a wireless level detector that detects the wireless level for a neighbor node on a logical network; and
a neighbor node number display controller that displays information indicative of the number of neighbor nodes communicable in the ad hoc mode on an incorporated or externally connected display device based on the detection result detected from the wireless level detector.

2. A wireless terminal communicable in an ad hoc mode, the wireless terminal comprising:
a wireless level detector that detects the wireless level for a neighbor node on a logical network; and
a wireless level display controller that displays the wireless level detected by the wireless level detector for each neighbor node on an incorporated or externally connected display device.

3. The wireless terminal according to claim 2, further comprising:
an actual connection node display controller that displays information indicative of neighbor nodes that the user's terminal actually uses for connection on the logical network on the incorporated or externally connected display device.

4. The wireless terminal according to claim 2, further comprising:
an identification information exchanger that exchanges information by which the user's node is distinguished from other neighbor nodes; and
an identification information display controller that displays the exchanged identification information on the incorporated or externally connected display device.

5. The wireless terminal according to claim 4, further comprising a light emitting element that can emit light having a color selected from a plurality of colors used to distinguish the user's node from the other nodes or a plurality of light emitting elements, each corresponding to each of the plurality of colors, wherein the identification information display controller drives the light emitting element to emit light having the emission color assigned to the user's node.

6. A wireless terminal communicable in a multi-hop ad hoc mode, the wireless terminal comprising:
a reached/unreached state detector that detects whether or not an ad hoc-routing communication route has been established between the user's terminal and a terminal apparatus specified as a destination connection point; and
a reached/unreached state display controller that displays the detection result from the reached/unreached state detector on an incorporated or externally connected display device.

7. A program that causes a computer housed in a wireless terminal communicable in an ad hoc mode to execute the processes of:
detecting the wireless level for a neighbor node on a logical network; and
deriving information indicative of the number of neighbor nodes communicable in the ad hoc mode based on the detection result of the wireless level and displaying the information on an incorporated or externally connected display device.

8. A program that causes a computer housed in a wireless terminal communicable in an ad hoc mode to execute the processes of:
detecting the wireless level for a neighbor node on a logical network; and
displaying the detected wireless level for each neighbor node on an incorporated or externally connected display device.

9. A program that causes a computer housed in a wireless terminal communicable in a multi-hop ad hoc mode to execute the processes of:
detecting whether or not an ad hoc-routing communication route has been established between the user's terminal and a terminal apparatus specified as a destination connection point; and
displaying the detection result on an incorporated or externally connected display device.
